(19) United States
(12) Patent Application Publication
(10) Pub. No.: US 2014/0040314 A1
(43) Pub. Date: Feb. 6, 2014

(54) METHOD AND SYSTEM FOR PROVIDING DATA ACCESS VIA A COMMON ACCESS MANAGER CONFIGURED TO SUPPORT SECURITY FOR MULTIPLE DATABASE MANAGEMENT SYSTEM TYPES

(71) Applicants: Fariborz Ebrahimi, Basking Ridge, NJ (US); Walid Hassan, Irving, TX (US); Sumit Singh, Irving, TX (US); Swamynathan Kuppuswamy, Irving, TX (US); Mirdul Jain, Irving, TX (US); Varun K. Maduri, Irving, TX (US)

(72) Inventors: Fariborz Ebrahimi, Basking Ridge, NJ (US); Walid Hassan, Irving, TX (US); Sumit Singh, Irving, TX (US); Swamynathan Kuppuswamy, Irving, TX (US); Mirdul Jain, Irving, TX (US); Varun K. Maduri, Irving, TX (US)

(73) Assignee: Verizon Patent and Licensing Inc., Basking Ridge, NJ (US)

(21) Appl. No.: 13/562,843

(22) Filed: Jul. 31, 2012

(51) Int. Cl. G06F 17/30

(52) U.S. Cl. 707/783; 707/E17.005

(57) ABSTRACT

An approach for providing data access via a common access manager configured to support security for multiple database management system types is described. A request specifying access for a user to a feature associated with one of a plurality of database management system types is determined by a common access manager configured to support the database management system types. A first-level approval of the access request by a first-level approver is determined. The access request is forwarded to a second-level approver based on the first-level approval. A provisioning of the access to the feature for the user is initiated based on a second-level approval by the second-level approver.

### BACKGROUND INFORMATION

Service providers are continually challenged to deliver value and convenience to consumers by providing compelling network services and advancing the underlying technologies. For example, service providers currently offer database management systems that enable businesses and other organizations to manage data access among various users. However, organizations (or even departments within an organization) typically have their own respective database management systems and separate platforms for managing access to data of those respective systems. Moreover, a database management system or platform of one organization/department may not be compatible with a database management system or platform of another organization/department. Thus, complexities and other issues may arise, for instance, during cooperation among the organizations or the departments within such organizations that require data access to databases managed by multiple systems and platforms.

Therefore, there is a need for an approach to more effectively manage data access, for example, by providing data access via a common access manager configured to support security for multiple database management system types.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing data access via a common access manager configured to support security for multiple database management system types, according to an embodiment;

FIG. 2 is a diagram of the components of a common access manager, according to an embodiment;

FIG. 3 is a flowchart of a process for providing data access via a common access manager configured to support security for multiple database management system types, according to an embodiment;

FIG. 4 is a flowchart of a process for handling an access request, according to an embodiment;

FIG. 5 is a diagram of an architecture that supports the processes of FIGS. 3 and 4, according to an embodiment;

FIG. 6 is a diagram of a workflow of an access request, according to an embodiment;

FIGS. 7A-7M are diagrams of user interfaces utilized in the processes of FIGS. 3 and 4, according to various embodiments;

FIG. 8 is a diagram of various components of a corporate performance manager, according to an embodiment;

FIG. 9 is another diagram of various components of a corporate performance manager, according to an embodiment;

FIG. 10 is a diagram of an infrastructure architecture with respect to a corporate performance manager, according to an embodiment;

FIG. 11 is a diagram illustrating a before/after scenario with respect to implementation of a corporate performance manager and/or a common access manager, according to an embodiment;

FIG. 12 is a diagram of a computer system that can be used to implement various embodiments; and

FIG. 13 is a diagram of a chip set that can be used to implement an embodiment of the invention.

### DESCRIPTION OF THE PREFERRED EMBODIMENT

An apparatus, method, and software for providing data access via a common access manager configured to support security for multiple database management system types are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

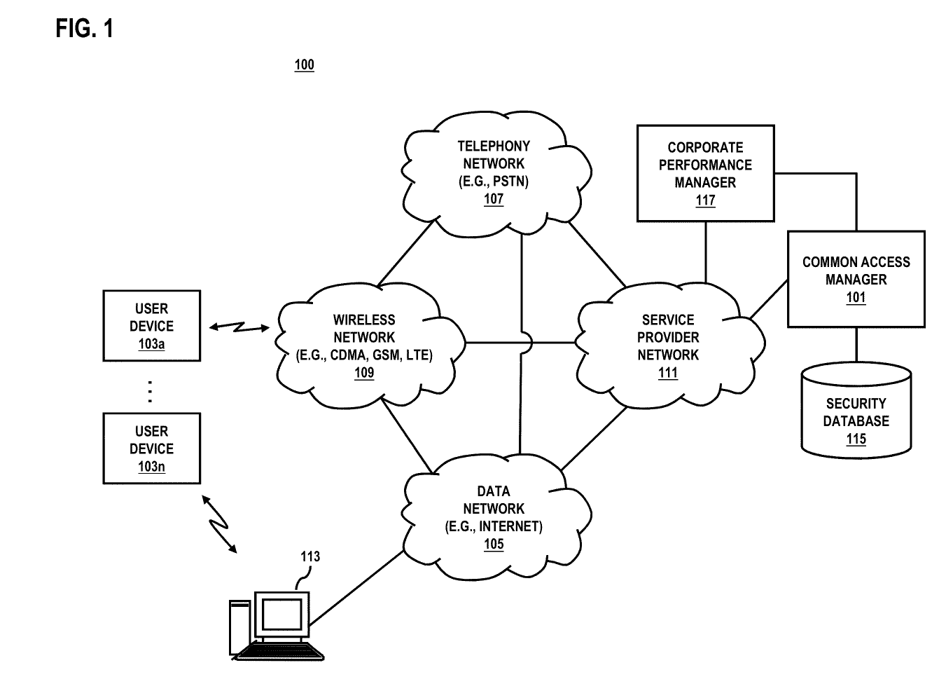

FIG. 1 is a diagram of a system capable of providing data access via a common access manager configured to support security for multiple database management system types, according to an embodiment. For the purpose of illustration, the system 100 employs a common access manager 101 that is configured to facilitate data access among different database management systems. One or more user devices 103 (or user devices 103a-103n) may, for instance, be utilized to initiate requests to access features (e.g., associated with roles, data groups, products, etc.) associated with various database management systems or system types over one or more networks (e.g., data network 105, telephony network 107, wireless network 109, service provider network 111, etc.). According to one embodiment, these services may be included as part of managed services supplied by a service provider (e.g., a wireless communication company) as a hosted or a subscription-based service made available to users of the user devices 103 through the service provider network 111. Such services include access management with respect to various roles, data groups, products, etc., for a user that enable the user to have access to corresponding data associated with multiple database management systems or system types. In this regard, common access manager 101 eliminates compatibility and complexity issues relating to working with data associated with different database management systems or system types.

As shown, the common access manager 101 may be a part of or connected to the service provider network 111. According to another embodiment, the common access manager 101 may be included within or connected to the user devices 103, a computing device 113, etc. In certain embodiments, the common access manager 101 may include or have access to a security database 115. The security database 115 may, for instance, be utilized to access or store access requests, access approvals, user profile information (e.g., assigned roles, data groups, etc., associated with a user), application profile information (e.g., access authorizations associated with an application), and compatibility data (e.g., data indicating limitations of various database management systems, code for interfacing with the various database management systems, etc.).

Moreover, the common access manager 101 may interact with a corporate performance manager 117 which may assist with many of the functions of the common access manager 101 (e.g., as will be described in further details below). In some embodiments, the corporate performance manager 117 may include the common access manager 101 to perform such functions. In other embodiments, common access manager 101 may direct and/or work with the corporate performance manager 117 to perform such functions. While specific reference will be made thereto, it is contemplated that the system 100 may embody many forms and include multiple and/or alternative components and facilities.

As mentioned, database management systems may be utilized by businesses and other organizations to manage data access among various users. However, organizations (or even departments within an organization) typically have their own respective database management systems and separate platforms for managing access to data of those respective systems. Each database management system may, for instance, vary in a number of ways. As an example, database management systems may differ as a result of the database models from which those database management systems are based (e.g., hierarchical database models, network database models, relational database models, object-oriented database models, multi-dimensional database models, etc.). Consequently, a platform for one database management system or system type may not be able to work with another database management system or system type (e.g., a platform for a database management system based on a relational database model may not be compatible with a database management system based on a multi-dimensional database model). Thus, a database management system or platform of one organization/department may not be compatible with a database management system or platform of another organization/department. Accordingly, complexities and other issues may arise, for instance, during cooperation among the organizations or the departments within such organizations that require data access to databases managed by multiple systems and platforms.

To address these issues, the system 100 of FIG. 1 provides the capability to facilitate data access among different database management systems via a common access manager (e.g., common access manager 101) configured to support security for multiple database management systems or system types. By way of example, the common access manager 101 may determine a request specifying access for a user to a feature associated with one of the database management systems or system types. If, for instance, a first-level approval by a first-level approver is determined, the common access manager 101 may forward the access request to a second-level approver. Then, the common access manager 101 may initiate provisioning of the access to the feature for the user upon a second-level approval by the second-level approver. As indicated, a feature may be associated with a role, a data group, a product, etc. For example, access to a particular feature may enable access to data corresponding to certain roles (e.g., functional security) or data corresponding to certain data groups (e.g., data security). In addition, the multi-tier approval process complements the ability of the common access manager 101 to support security for multiple database management systems or system types. In one use case, the second-level approver may be a designated project leader for two different departments, while the first-level approver may be a supervisor at one of the departments. Request for assignments of certain roles or data groups to a user may, for instance, encompass data access to databases associated with database management systems of both departments. As such, the data access may require the approval of both the supervisor and the designated project leader.

In some embodiments, the access request may further specify access for the user to another feature associated with another one of the database management systems or system types. In this way, an access request may simultaneously indicate assignments to various roles, data groups, products, etc., for a user that enable the user access to data associated with different database management systems or system types. In certain embodiments, the data may be integrated from a plurality of source systems associated with the database management systems or system types. As such, the common access manager 101 may increase the ease of cooperation among multiple organizations or departments, for example, that may utilize different database management systems or system types.

In one scenario, for instance, the common access manager 101 may be based on an architecture that enables the maintenance of security for Oracle RDBMS (Relational Database Management System), OBIEE (Oracle Business Intelligence Suite Enterprise Edition), Essbase, Hyperion Suite, J2EE Applications, ADF (Application Development Framework) Applications, etc., from a single platform (e.g., a single user interface platform). In addition, such an architecture may allow Single Sign-On-enabled security, for instance, between OBIEE and Essbase, OBIEE and Oracle RDBMS, OBIEE and Hyperion workspace, OBIEE and JE22/ADF Applications, JEEE/ADR Applications and Oracle RDBMS, J2EE/ADR Applications and Essbase, etc. As such, in various embodiments, the common access manager 101 may provide extensive monitoring capabilities for an entire history of changes made to security access of one or more users (e.g., as opposed to just presentation of the last updated changes). In other embodiments, the common access manager 101 may be integrated with BPM (Business Process Management) products for managing human workflow, for example, so that the security approval process is audited and followed according to corporate standards.

In another embodiment, the common access manager 101 may assign the access request to another first-level approver based on the determination of the access request. Subsequently, the common access manager 101 may reassign the access request to the first-level approver based on a reassignment with respect to approving the access request, and the first-level approval of the access request may be based on the reassignment of the access request. In one use case, a particular approver (e.g., the other first-level approver) may initially be assigned to handle a request soliciting allocation of a certain role for a user that would give the user access to data corresponding to the role. However, the initially-selected approver may not be the appropriate person for the task of authorizing the allocation of the role to the user. As such, the initially-selected approver may initiate a reassignment of the access request to a different approver (e.g., the first-level approver). Such actions by the initially-selected approver may thus cause the common access manager 101 to reassign the access request to the appropriate approver (e.g., the first-level approver).

In another embodiment, the common access manager 101 may determine a selection of a filter for the access to the feature, the access request may indicate the selection of the filter, and the provisioning of the access may be based on the selection of the filter. In one scenario, the access request may specify the desired data group for a user. In addition, the request may either specify “Full Access” to the data associated with the desired data group or “Filtered Access” to the data associated with the desired data group. If, for instance, “Filtered Access” is indicated, the access request may also specify the filters that should be implemented for the user's access (e.g., filters listing sub-groups that the user should be limited to).

In another embodiment, the common access manager 101 may determine that the first-level approver, the second-level approver, or a combination thereof has requested additional information with respect to the access request. As such, the common access manager 101 may initiate an action to satisfy the additional information request. For example, a request may specify that a user seeks to be assigned to a particular data group that would enable the user to have access to data corresponding to the data group. In assessing the assess request, a first-level approver or a second-level approver may also wish to know how long the user will be working with the data group, what types of tasks the user will be handling, etc., for instance, to limit the access to a certain time frame, to implemented additional filters for the access, etc. Thus, the first-level approver or the second-level approver may initiate a request specifying the additional information that is desired. As a result, the common access manager 101 may seek the additional information from the submitter of the access request, the user, etc.

In another embodiment, the common access manager 101 may initiate cancellation of the access request (e.g., prior to completion of the provisioning of the access, after completion of the provisioning, etc.) based on a withdrawal by an initial submitter of the access request, the user, or a combination thereof. In one scenario, a project leader may submit the access request on behalf of a user. After the access request is submitted, the project leader may determine that it is no longer necessary for the user to have the access specified in the request. As such, the project leader may initiate a withdrawal of the access request. Accordingly, the access request may be canceled prior to the provisioning being completed. In another scenario, the user may realize that the project leader has submitted the access request on the user's behalf. The user may realize that he/she no longer needs the access specified in the request. Thus, the common access manager 101 may also enable the user to initiate a withdrawal to have the access request canceled before the provisioning is completed.

It is noted that the common access manager 101, the user devices 103, the computing device 113, the corporate performance manager 117, and other elements of the system 100 may be configured to communicate via the service provider network 111. According to certain embodiments, one or more networks, such as the data network 105, the telephony network 107, and/or the wireless network 109, may interact with the service provider network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

Further, it is noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

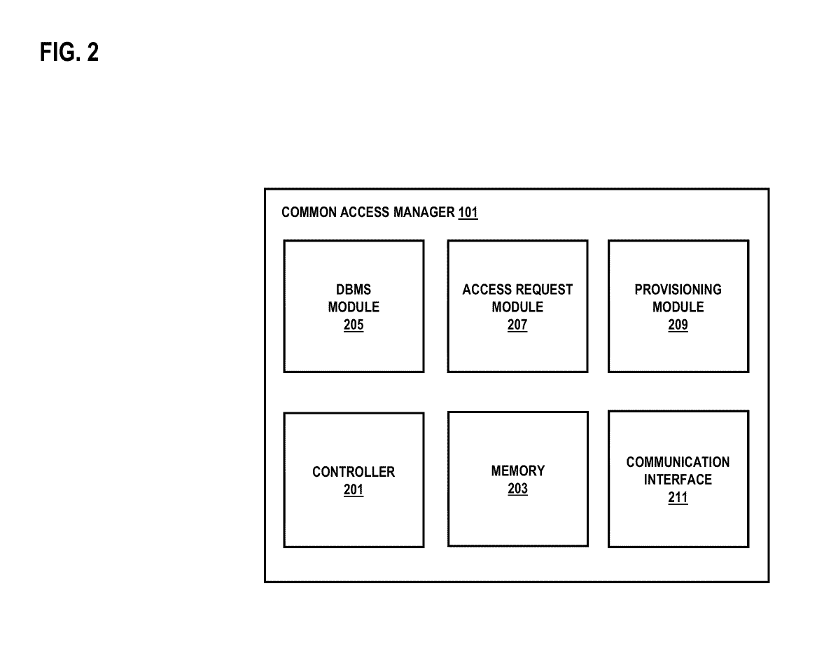

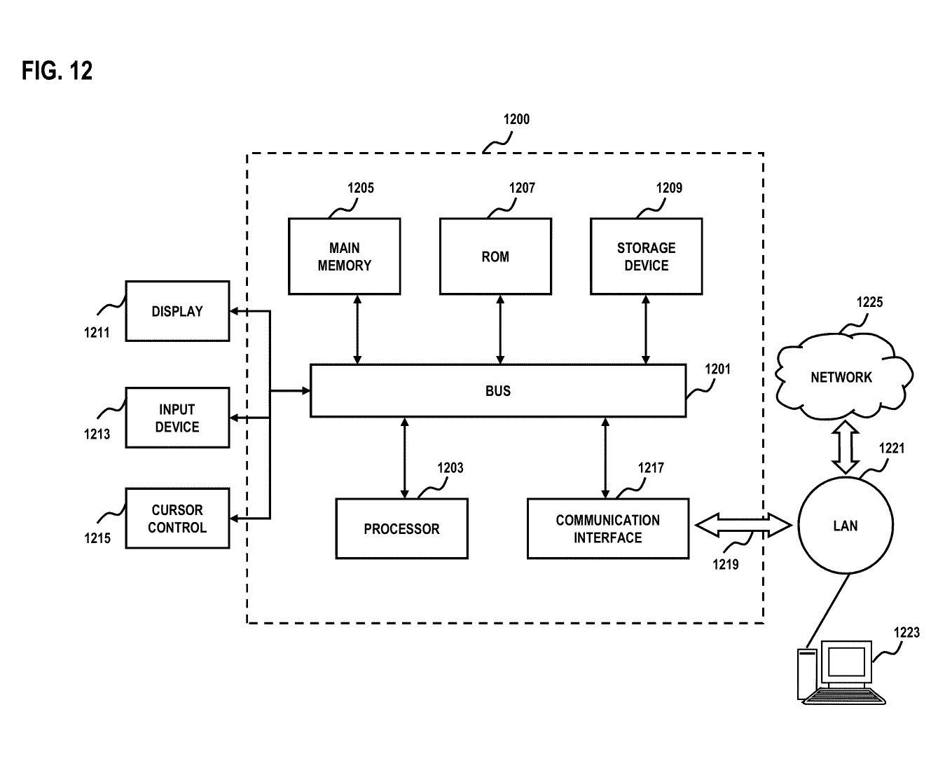

FIG. 2 is a diagram of the components of a common access manager, according to an embodiment. The common access manager 101 may comprise computing hardware (such as described with respect to FIG. 12), as well as include one or more components configured to execute the processes described herein for providing data access via a common access manager configured to support security for multiple database management system types. It is contemplated that the functions of these components may be combined in one or more components or performed by other components of equivalent functionality. In certain embodiments, the common access manager 101 includes a controller (or processor) 201, memory 203, a database management system (DBMS) module 205, an access request module 207, a provisioning module 209, and a communication interface 211.

The controller 201 may execute at least one algorithm for executing functions of the common access manager 101. For example, the controller 201 may work with the DBMS module 205 to support security for a plurality of database management system types. In some embodiments, the DBMS module 205 may utilize an application programming interface (API) configured for the database management system types to initiate calls to databases associated with the database management system types. A call to a database (e.g., to manipulate the data in the database) may, for instance, be based on an identifier that specifies the database management system that that the database is associated with. As such, the call to the database may be customized for the particular database management system.

The controller may also interact with the access request module 207 to determine a request specifying access for a user to a feature associated with one of the database management system types. Then, upon determination of the access request, the access request module 207 may assign the access request to a first-level approver. If, for instance, a first-level approval is granted by the first-level approver, the access request module 207 may forward the access request to a second-level approver. If a second-level approval is granted by the second-level approver, the access request module 207 may then direct the provisioning module 209 to initiate provisioning of the access to the feature for the user. In various embodiments, one or more additional approvals by other approvers (e.g., a third-level approval by a third-level approver) may be required prior to the provisioning of the access.

In some embodiments, the access request may further specify access for the user to another feature associated with another one of the database management system types. In this way, for instance, an access request may simultaneously seek assignments to various roles, data groups, products, etc., for a user that enable the user to have access to data associated with different database management system types. In certain embodiments, the data may be integrated from a plurality of source systems associated with the database management system types. As such, the common access manager 101 may increase the ease of cooperation among multiple organizations or departments, for example, that may utilize different database management systems or system types.

Furthermore, the controller 201 may utilize the communication interface 211 to communicate with other components of the common access manager 101, the user devices 103, and other components of the system 100. The communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication.

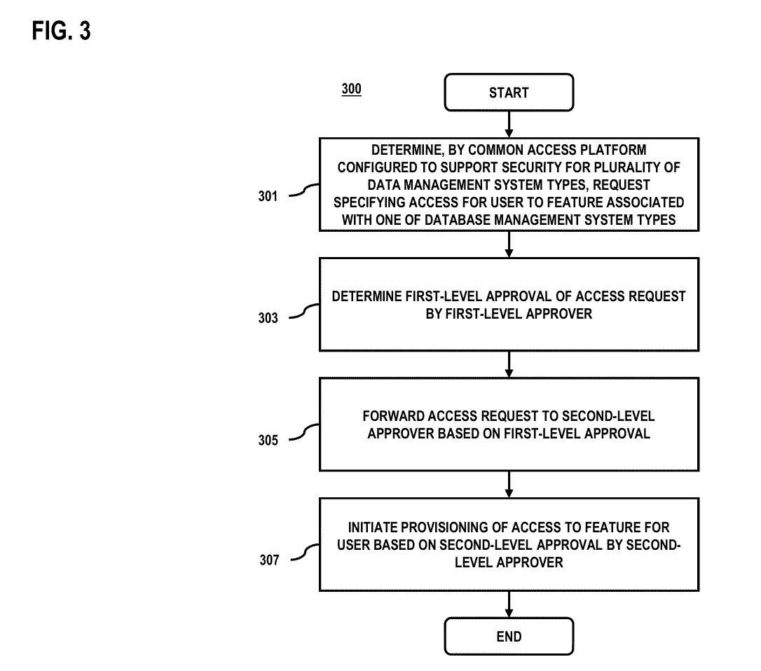

FIG. 3 is a flowchart of a process for providing data access via a common access manager configured to support security for multiple database management system types, according to an embodiment. For the purpose of illustration, process 300 is described with respect to FIG. 1. It is noted that the steps of the process 300 may be performed in any suitable order, as well as combined or separated in any suitable manner. In step 301, the common access manager 101 may determine a request specifying access for a user to a feature associated with one of a plurality database management system types. As indicated, in certain embodiments, the access request may further specify access for the user to another feature associated with another one of the database management system types. The feature may, for instance, be associated with a role, a data group, a product, or a combination thereof, and the other feature may be associated with another role, a data group, a product, or a combination thereof. Thus, a single access request may simultaneously seek assignments to various roles, data groups, products, etc., for a user to enable the user to have access to data associated with different database management system types.

In addition, as discussed, the common access manager 101 may be configured to support the plurality of database management system types. As such, in various embodiments, the common access manager 101 may also integrate data from a plurality of source systems associated with the database management system types. In this way, the common access manager 101 may increase the ease of cooperation among multiple organizations or departments, for example, that may utilize different database management system types.

In step 303, the common access manager 101 may determine a first-level approval of the access request by a first-level approver. By way of example, the access request may be assigned to a first-level approver to handle approval with respect to the specified access upon the determination of the access request. If, for instance, the first-level approver approves the specified access, the common access manager 101 may forward the access request to a second-level approver based on the first-level approval (step 305).

In step 307, the common access manager 101 may initiate provisioning of the access to the feature for the user based on a second-level approval by the second-level approver. For example, if the second-level approver grants the second-level approval, the common access manager 101 may determine whether one or more additional approvals by other approvers (e.g., a third-level approval by a third-level approver) is required prior to the provisioning of the access. If it is determined that the first-level approval and the second-level approval is sufficient to provision the access, the common access manager 101 may start the provisioning process without seeking additional approvals. Upon completion/success of the access provisioning, the common access manager 101 may further send a notification (e.g., via email) to the user to inform the user that the access provisioning was successful.

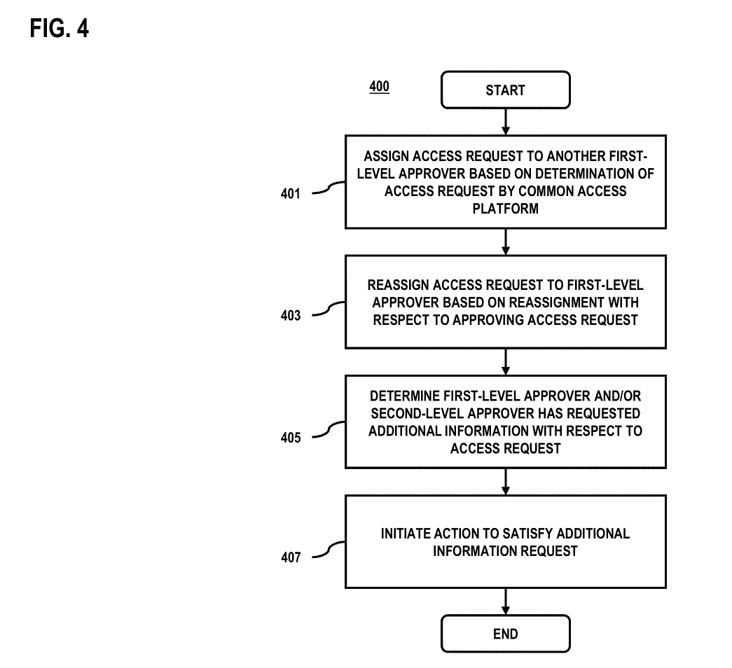

FIG. 4 is a flowchart of a process for handling an access request, according to an embodiment. For the purpose of illustration, process 400 is described with respect to FIG. 1. It is noted that the steps of the process 400 may be performed in any suitable order, as well as combined or separated in any suitable manner. In step 401, the common access manager 101 may assign the access request to another first-level approver based on the determination of the access request. However, in step 403, the common access manager 101 may then reassign the access request to the first-level approver based on a reassignment with respect to approving the access request. By way of example, when the access request is received, it may originally be assigned to an initial approver (e.g., the other first-level approver). However, the initially-selected approver may seek a reassignment of the access request if, for instance, the initially-selected approver is not the appropriate person for handling the request, does not have time to handle the request, etc. As such, in one use case, the common access manager 101 may automatically reassign the access request to a different approver (e.g., the first-level approver) who is deemed appropriate for the approval task based on a determination that the initially-selected approver is seeking the reassignment.

As discussed, in certain embodiments, the common access manager 101 may determine that the first-level approver, the second-level approver, or a combination thereof has requested additional information with respect to the access request (step 405). Thus, in step 407, the common access manager 101 may initiate an action to satisfy the additional information request. In one scenario, for instance, a request may specify that a user seeks to be assigned to a particular data group that would enable the user to have access to data corresponding to the data group. In assessing the assess request, a first-level approver or a second-level approver may also wish to know how long the user will be working with the data group, what types of tasks the user will be handling, etc., for instance, to limit the access to a certain time frame, to implemented additional filters for the access, etc. Thus, the first-level approver or the second-level approver may initiate a request specifying the additional information that is desired. As a result, the additional information may be requested from the submitter of the access request, the user, etc.

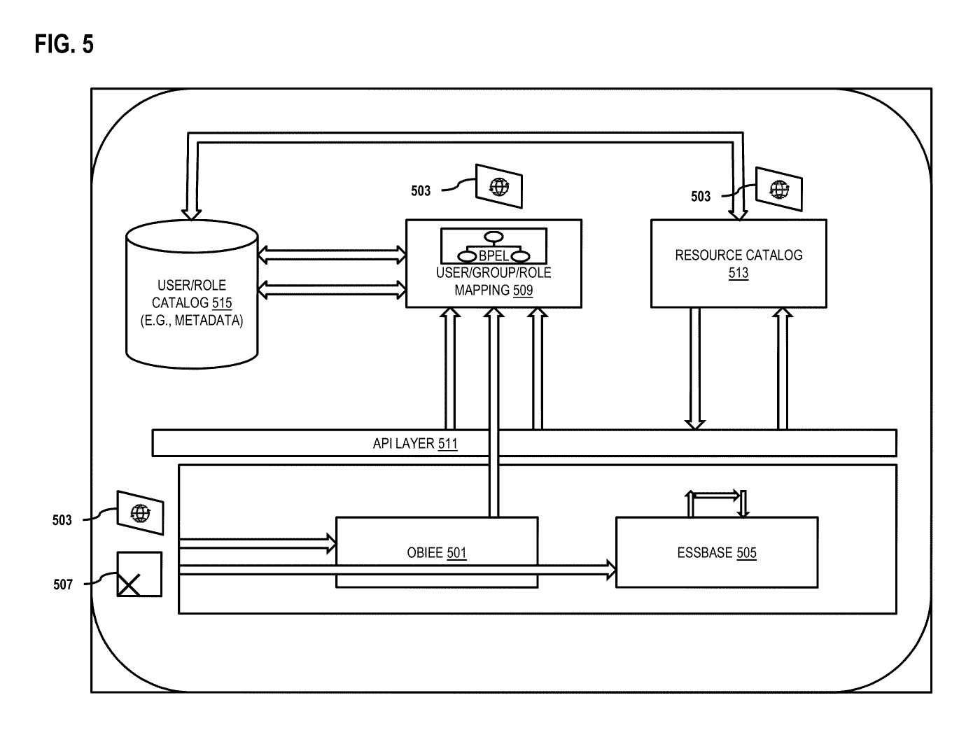

FIG. 5 is a diagram of an architecture that supports the processes of FIGS. 3 and 4, according to an embodiment. As shown, OBIEE 501 may fetch group/role information from the common access manager 101 using, for instance, JDBC (Java Database Connectivity) calls via ADF applications (e.g., indicator 503). Essbase 505 may also fetch group/role information from the common access manager 101 using, for example, a spreadsheet application plug-in (e.g., indicator 507). In addition, OBIEE 501 and Essbase 505 may contain native group/role information for resource entitlement setup. As depicted, the common access manager 101 may form user/group/role mappings 509 (e.g., based on BPEL (business process execution language)) by pulling the native mappings from OBIEE 501 and Essbase 505 via the API layer 511. The API layer 511 may also be utilized to push user/group/role/resource/filters mappings between Essbase 505 and resource catalog 513. Moreover, data may be exchanged between the resource catalog 513 and the user/role catalog 515. Furthermore, the common access manager 101 may utilize data from the user/role catalog 515 and the user/group/role mappings 509 to perform the access provisioning process for users.

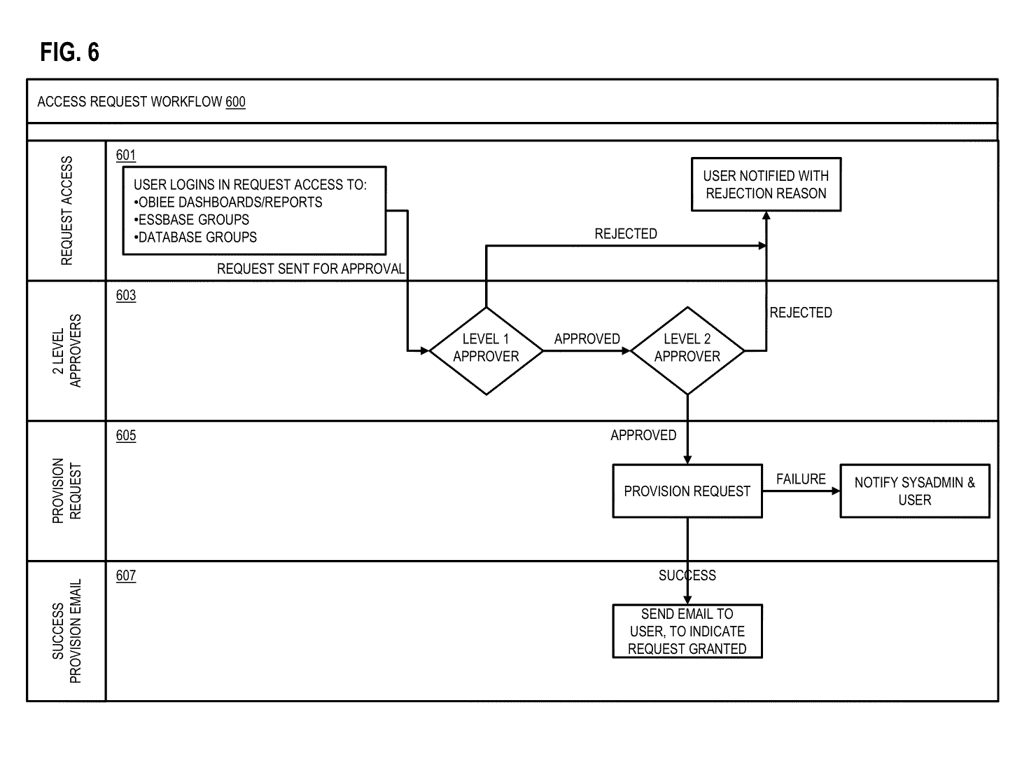

FIG. 6 is a diagram of a workflow of an access request, according to an embodiment. As shown, the access request workflow 600 includes stages 601, 603, 605, and 607. In stage 601, a user may initiate a request to specify and seek assignment to various roles, data groups, products, etc., that would enable the user to access data relating to those items. By way of example, a first-time user may be prompted with a user access request form when the user tries to log into a platform associated with the common access manager 101 for the first time. In addition, existing users may also submit access requests for access to additional roles, data groups, products, etc., by clicking on an access request link using the platform. As depicted, the access request initiated by the user specifies that the user is seeking access to data/functions relating to OBIEE dashboards/reports, Essbase groups, and other database groups.

In stage 603, the access request is sent to a first-level approver for a first-level approval. If, for instance, the first-level approver grants the first-level approval, the access request may then be forwarded to a second-level approver for a second-level approval. Upon a grant of the second-level approval by the second-level approver, the access request may subsequently be pushed into stage 605 to initiate provisioning of the specified access. However, if the access request is rejected by either the first-level approver or the second-level approver, the process may be bumped back to stage 601 where the user may be notified of the rejection along with a reason for the rejection.

As discussed, in stage 605, the provisioning of the access may be initiated upon the first-level and second-level approvals. If a failure occurs with respect to the provisioning process, the user and a system administrator may be notified to resolve the issue. On the other hand, if the provisioning process is completed and, thus, successful, an email may be sent to the user to inform the user that the specified access in the request has been granted and successfully provisioned (stage 607).

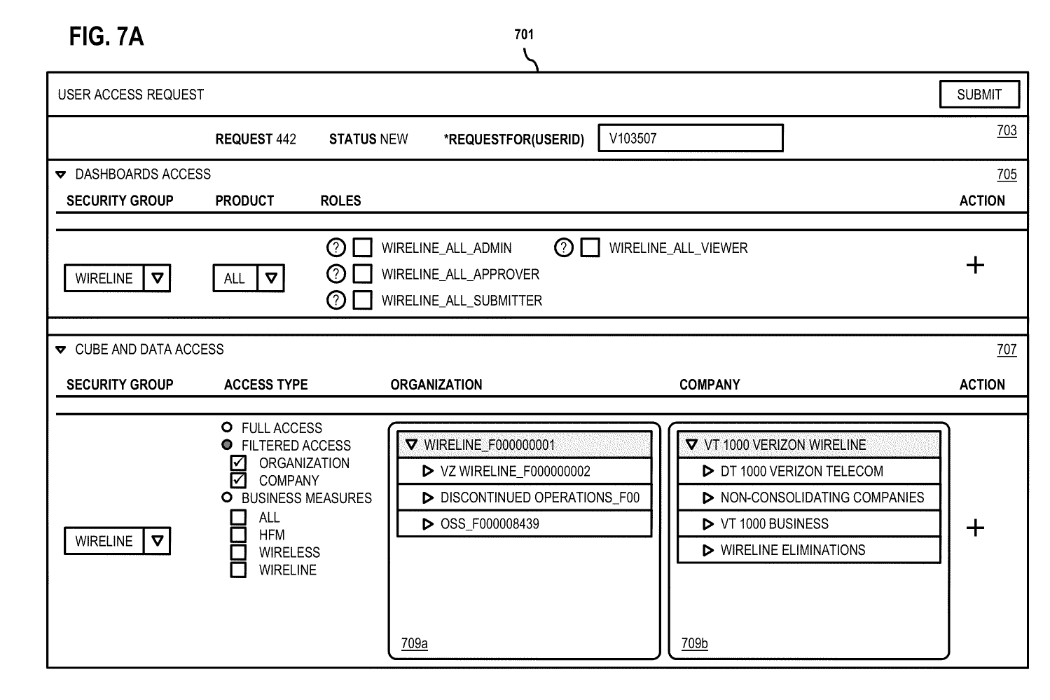

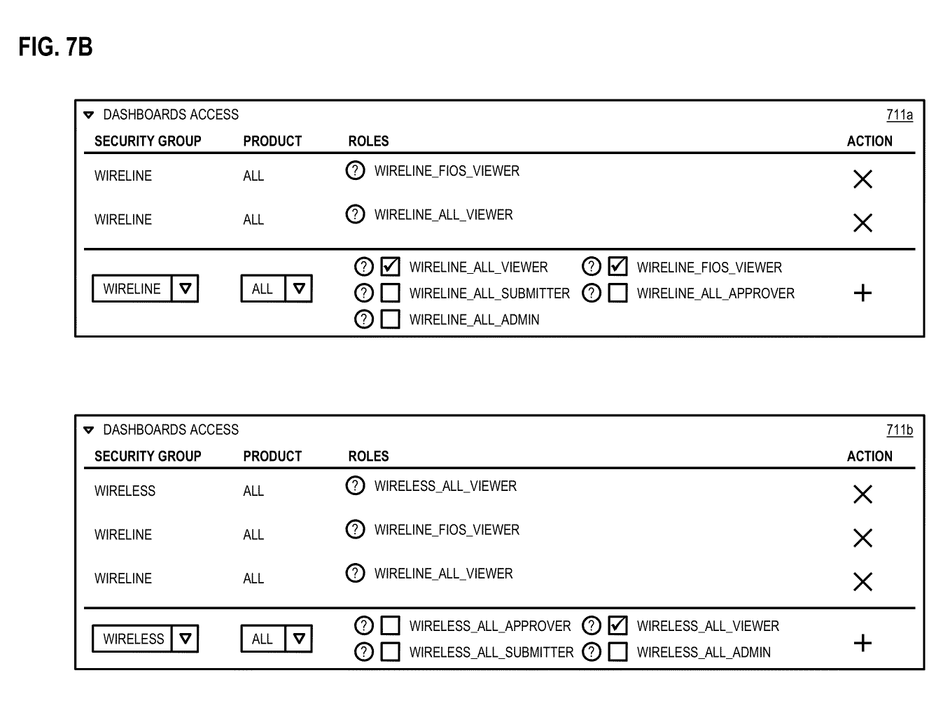

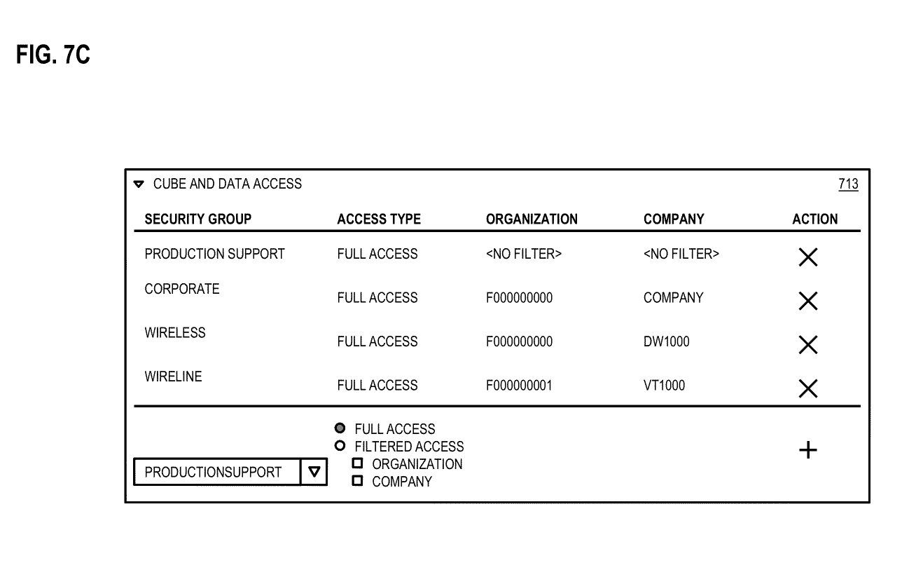

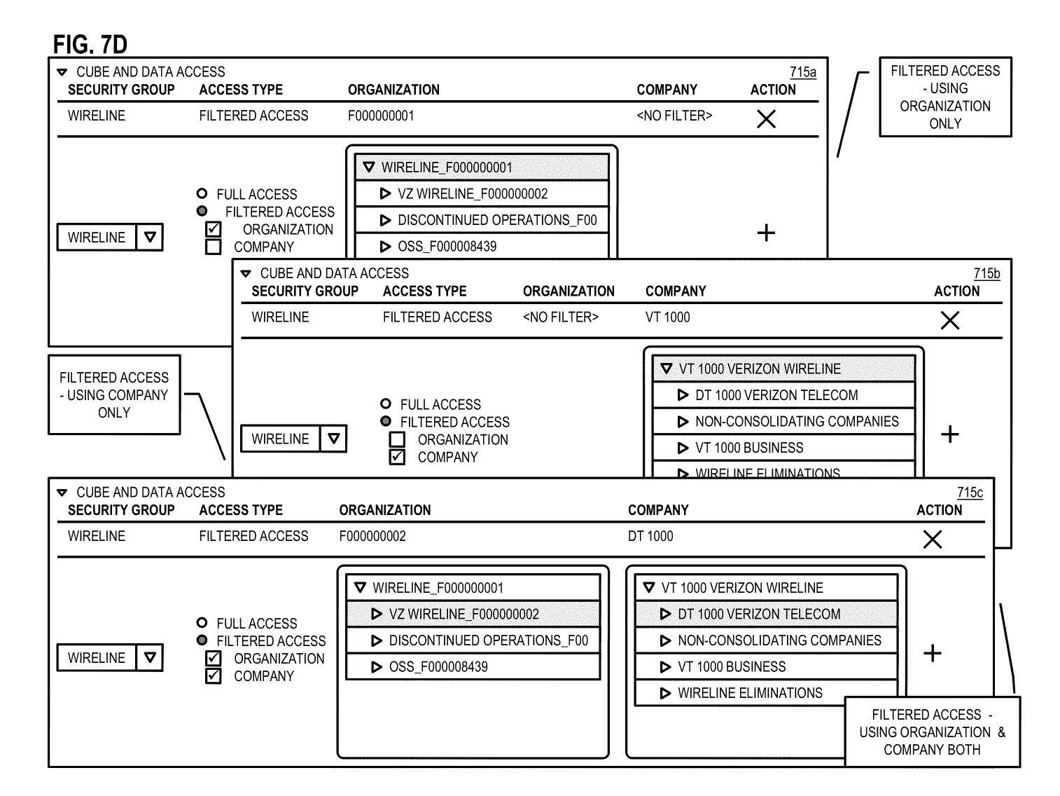

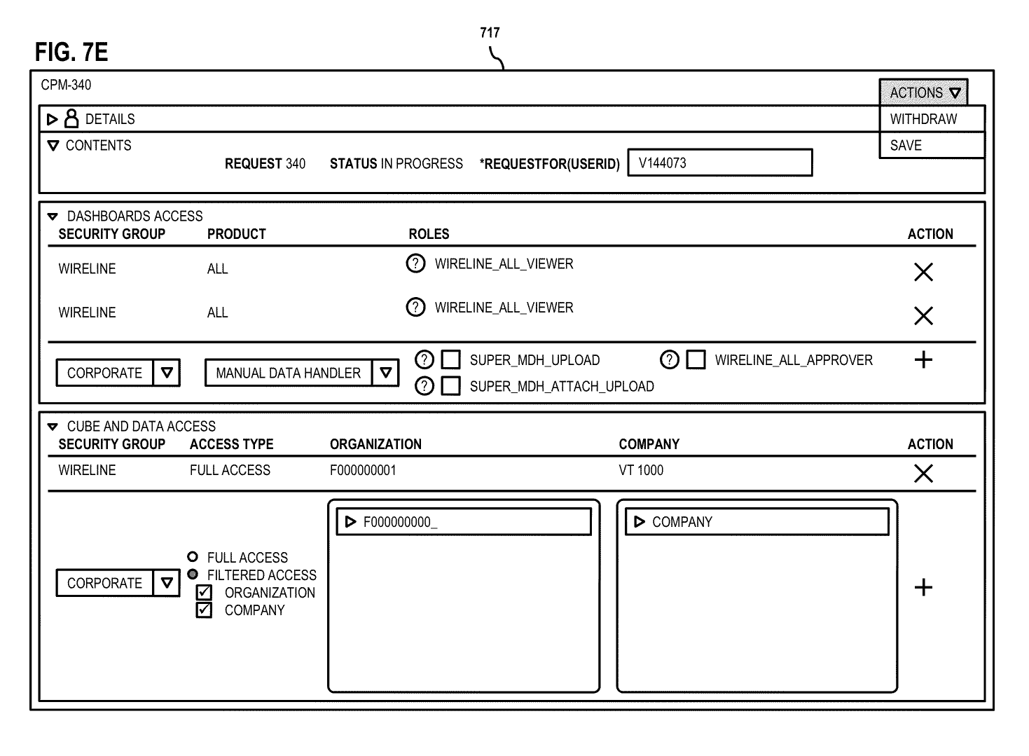

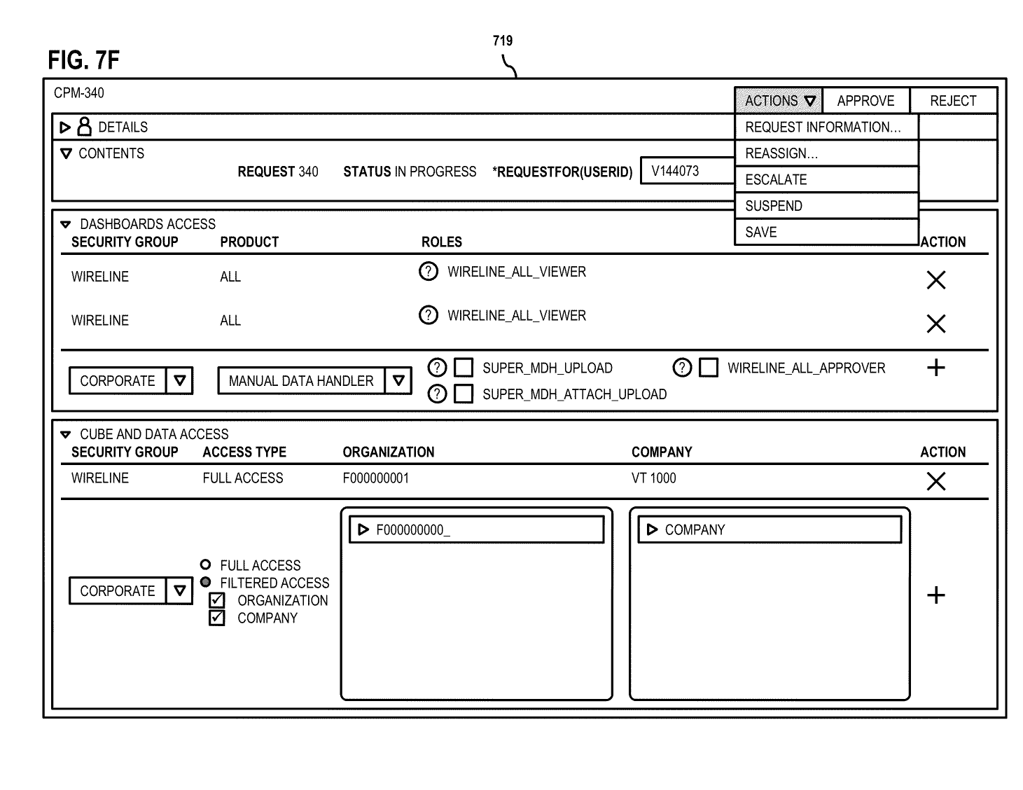

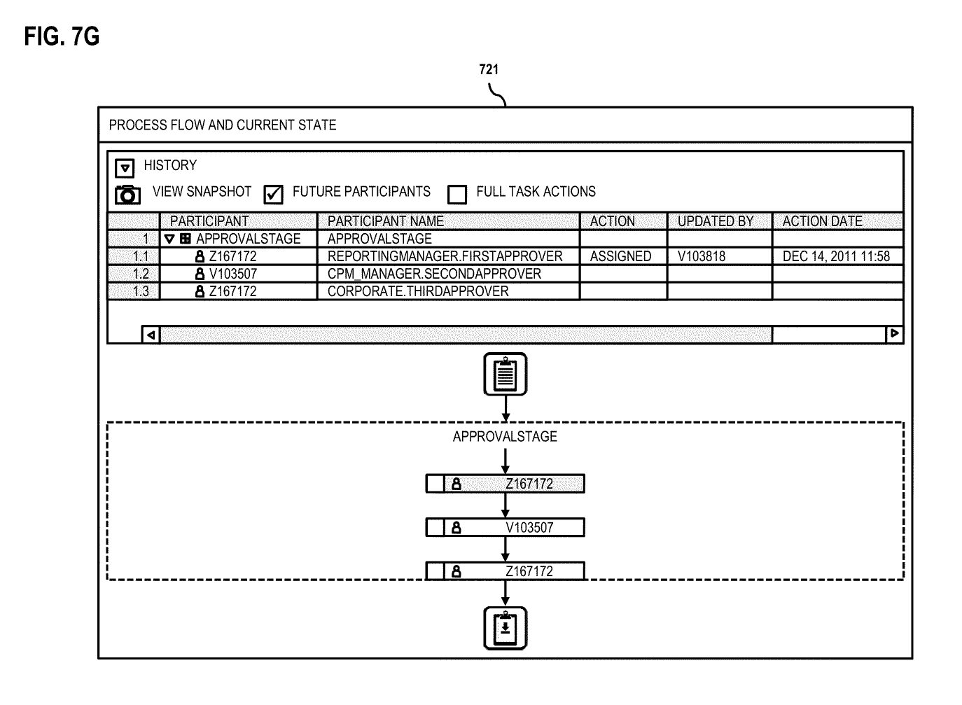

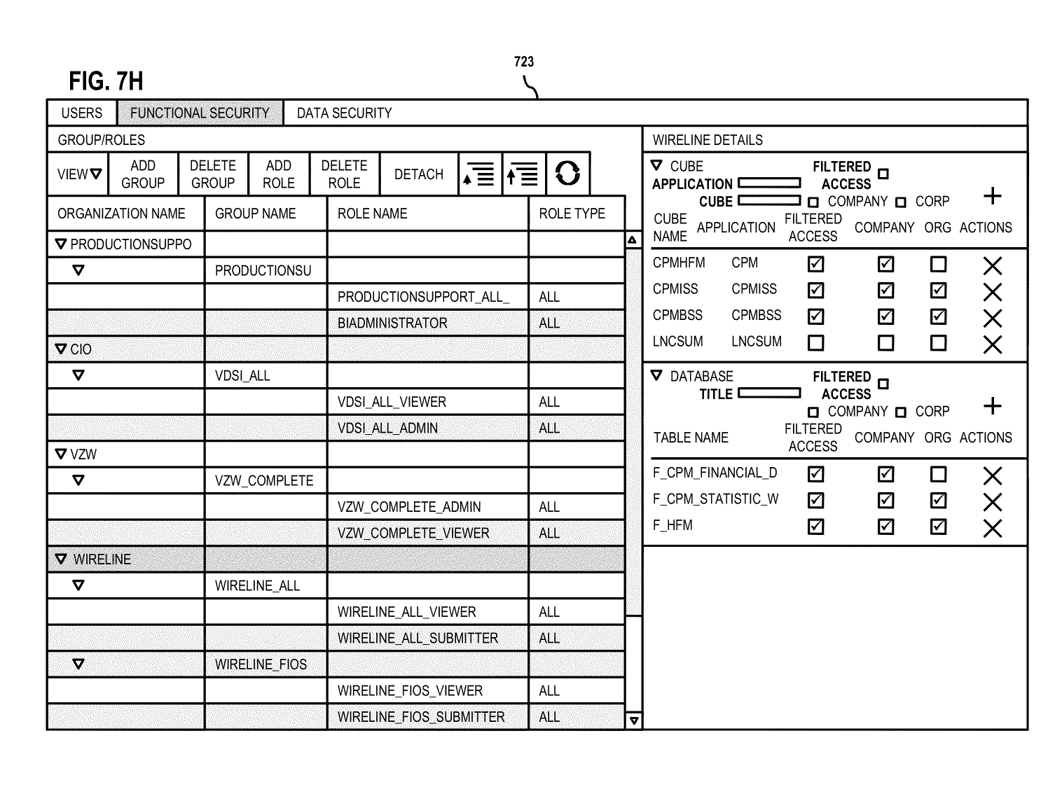

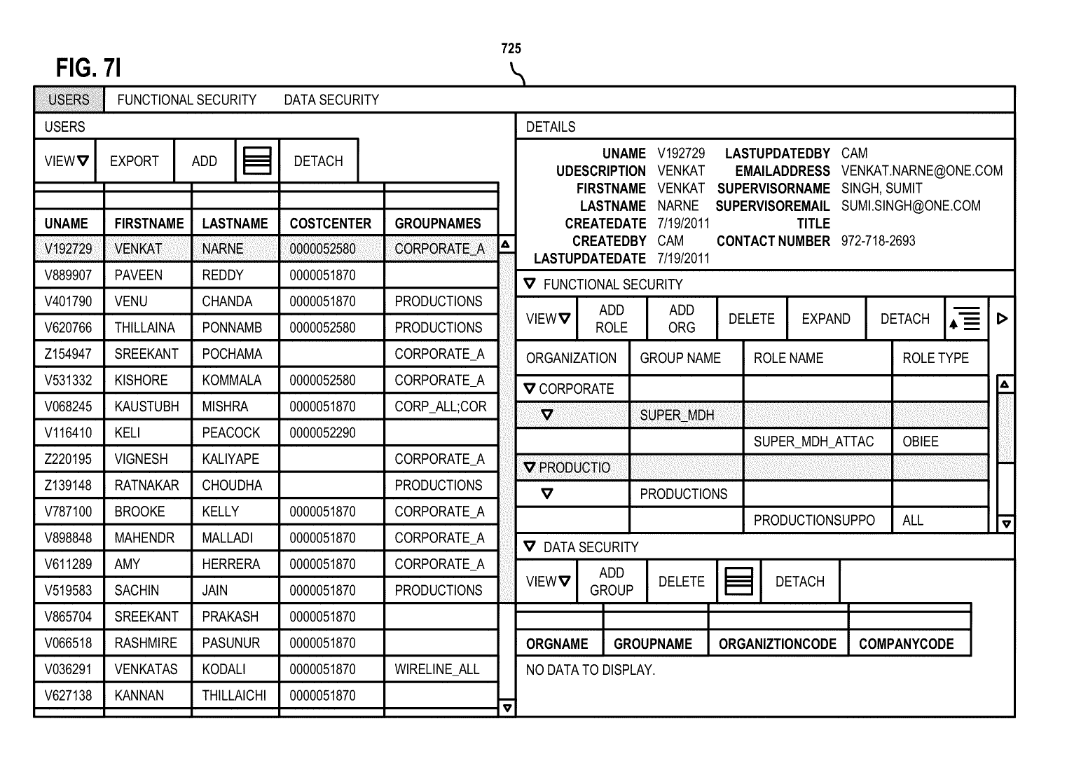

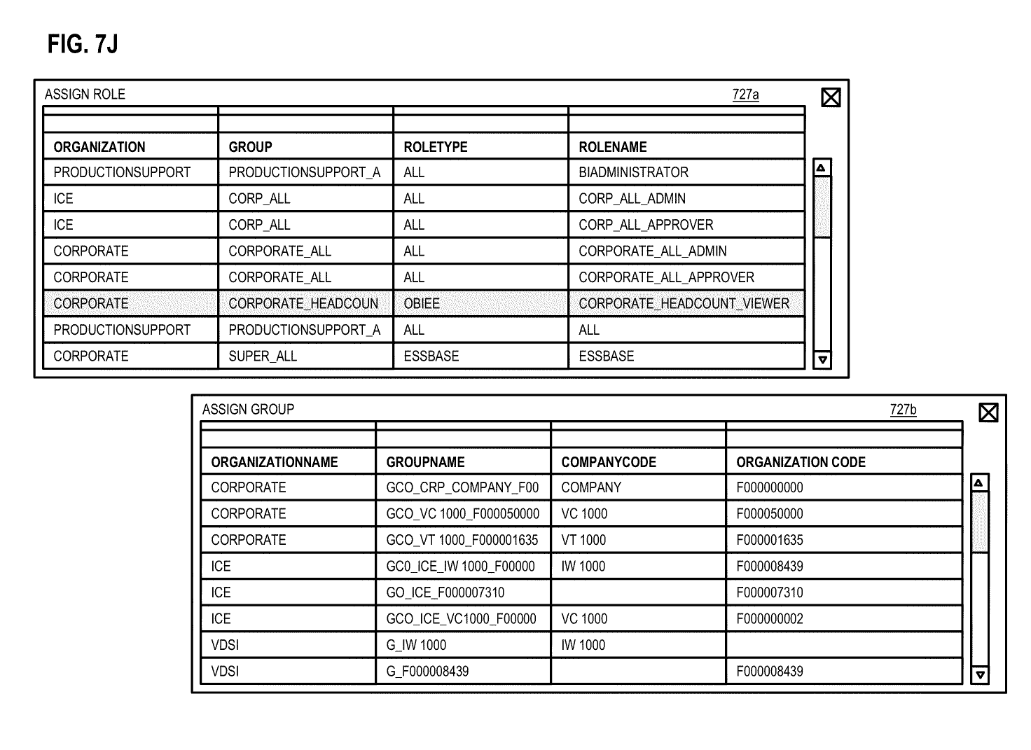

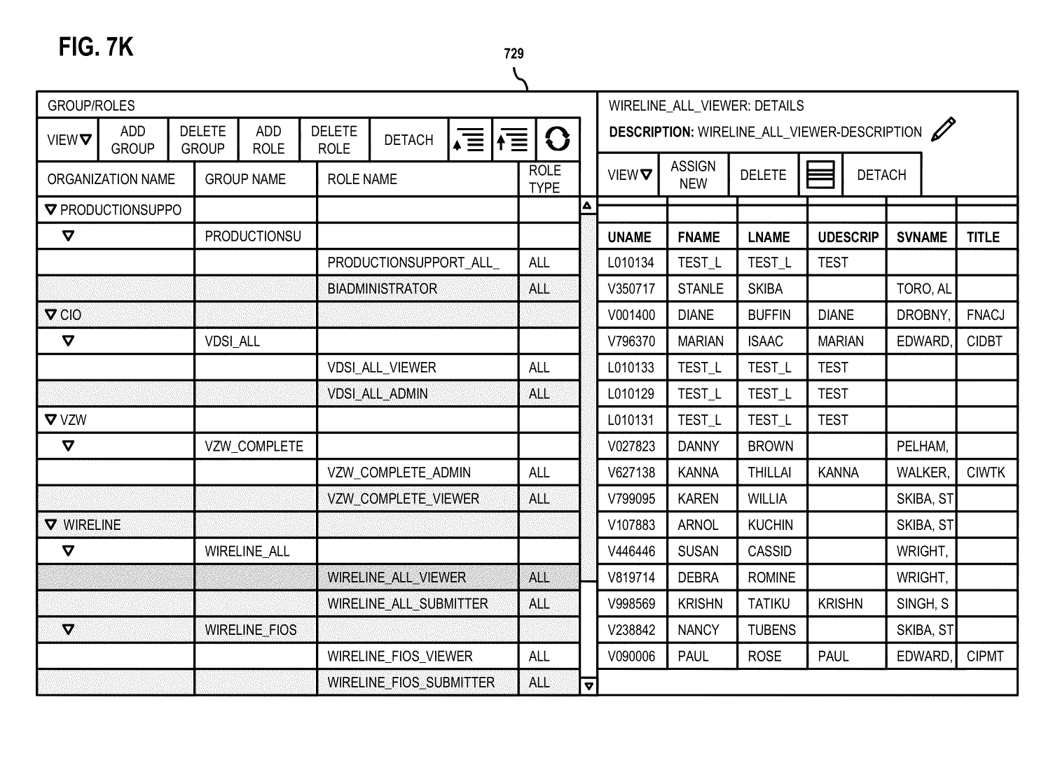

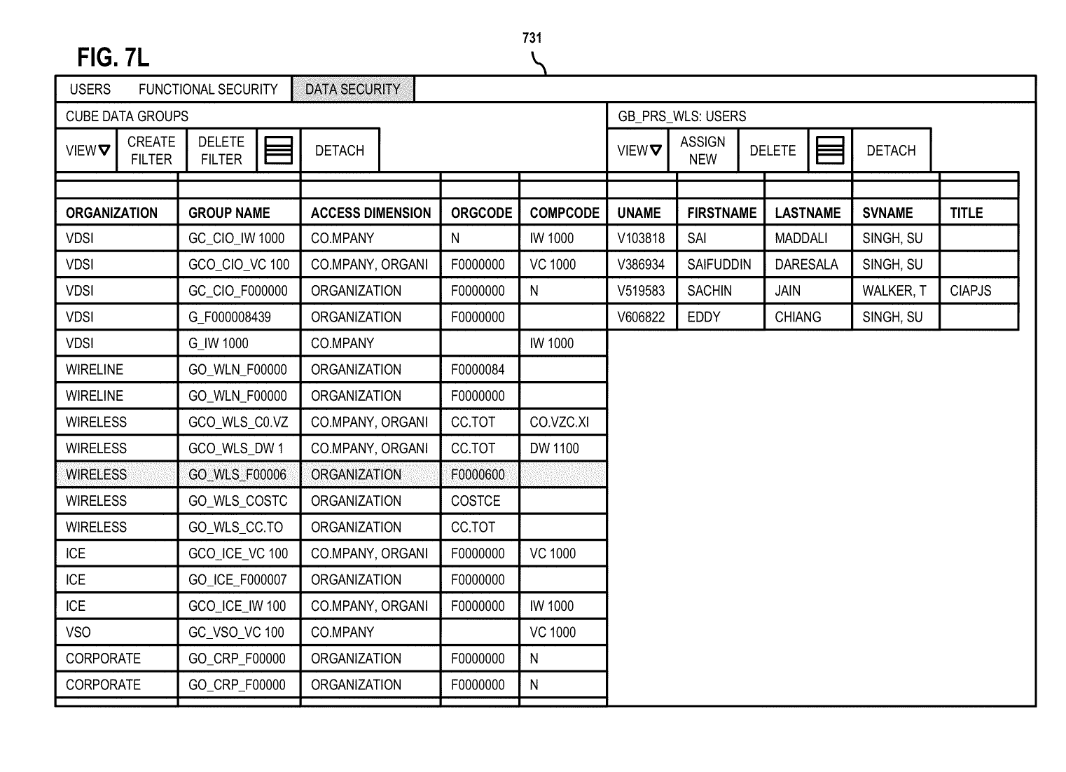

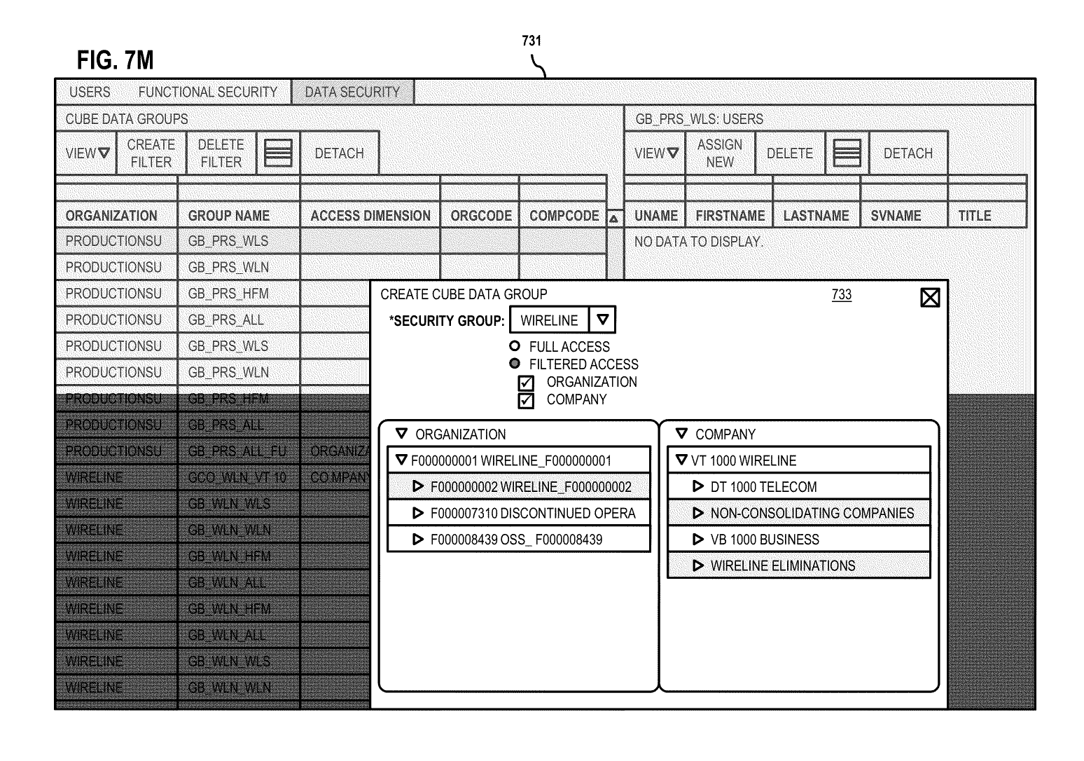

FIGS. 7A-7M are diagrams of user interfaces utilized in the processes of FIGS. 3 and 4, according to various embodiments. For example, FIG. 7A depicts a user interface 701 with a user access request form that enables a submitter to submit a single request for multiple accesses. In section 703, the submitter of the access request may be provided with a unique request identifier (e.g., 442) for future request information look-ups and the status information (e.g., New). The submitter may also indicate the user for which access is requested by filling out user identification information (e.g., V103507) in section 703. In section 705, the submitter may select the security group (e.g., line of business (LOB)) that the user should have dashboard access for (e.g., wireline, wireless, service office, etc.), the products that the user should have dashboard access to (e.g., all), and single or multiple roles that the user should be assigned (e.g., wireline_all_admin, wireline_all_approver, wireline_all_submitter, wireless_all_viewer, etc.). In addition, the submitter may find out additional details and descriptions about a particular role by clicking on the “?” icon next to the role.

In section 707, the submitter may select the security group that the user should have cube and database access for, and the access type (e.g., full access, filtered access, etc.). As shown, the submitter has specified that the user should have filtered access based on organizational filters and company filters. Thus, sub-sections 709a and 709b are presented to enable the submitter to select the organizations and companies for the filtered access. Moreover, as illustrated, sections 705 and 707 include “+” icons to indicate that the submitter may add additional buttons, items, roles, access types, etc., respectively to sections 705 and 707 if the current selection is insufficient. In addition, system administrators can create filters or other items, and feed those items to the user access request form, from a control screen. As an example, such data level security may be implemented for Essbase cubes/dimensions, for database tables, etc. Data level security is, for instance, applicable to users browsing dashboards and reports from OBIEE, users using Smart Excel Plug-ins, users using Essbase Add-ons, users analyzing data, users trying to access cube data, users connecting to databases through any database developer tool, etc.

FIG. 7B illustrates selection of multiple roles in multiple security groups for a single access request. As shown, instance 711 a of the section 705 provides the submitter with options associated with the wireline group (e.g., the selected security group). In this case, the submitter has selected two roles (e.g., wireline_all_viewer and wireline_fios_viewer) in instance 711a to cause those two roles to appear in the middle of section 705 (e.g., to demonstrate that they have been selected). The submitter may also select other roles in other security groups by clicking on the group drop-down menu and selecting other security groups. As depicted, in instance 711b, the submitter has selected the wireless group. Thus, instance 711b provides the submitter with options associated with the wireless group. In instance 711b, the submitter has selected one role associated with the wireless group (e.g., wireless_all_viewer) to cause the selected wireless role to appear in the middle of section 705 with the selected wireline roles.

FIG. 7C illustrates selection of access types and filters for multiple security groups for a single access request. As shown, instance 713 of the section 707 provides the submitter with options for full or filtered access for each of the selected security groups. In this case, full access for a security group means top-level company and organization access for that security group. Selection of filtered access enables the submitter to select various levels of company and organization access for the user identified in the request. FIG. 7D further illustrates selection of access types and filters. For example, instance 715a of the section 707 depicts the selection of filtered access for the wireline group using only the organization item, instance 715b depicts the selection of filtered access for the wireline group using only the company item, and instance 715c depicts the selection of filtered access for the wireline group using both the organization and company items.

FIG. 7E illustrates a user interface 717 depicting a user access request where the user interface 717 is a user interface for submitters of access requests. As shown, the request identification number associated with the request is “340,” the status is “In Progress,” and the request is specified for a user with the user identification number “V144073.” In this case, the submitter of the access request may utilize options in the top right corner of the user interface 717 to withdraw the access request or save recent changes made to the access request. As indicated, selecting the action to withdraw the access request may initiate cancellation of the request (e.g., prior to completion of the provisioning of the access, after completion of the provisioning, etc.).

FIG. 7F illustrates a user interface 719 depicting a user access request where the user interface 719 is a user interface for approvers of access requests. In this case, a selected approver for the access request may utilize options in the top right corner of the user interface 719 to approve or reject the access request. In addition, the approver may utilize other options in the top right corner of the user interface 719 to request additional information, reassign the access request to another approver, escalate the access request, suspend the access request, or save recent changes made to the access request.

FIG. 7G illustrates a user interface 721 depicting the process flow and current state of an access request. As shown, the user interface 721 may present an entire history with respect to steps of the process that has already occurred, all potential steps of the process, etc., to one or more users (e.g., the submitter of the access request, the user for which the access is specified for, potential approvers, administrators, etc.). For example, the user interface 721 demonstrates that the access request was assigned to a first-level approver having user identification “Z167172” by a user having user identification “V103818” on Dec. 14, 2011.

FIG. 7H illustrates function security management of security groups. As shown, user interface 723 depicts its functional security section in view mode (e.g., based on a selection of the function security tab of the user interface 723). Details associated with cube and database access with respect to all roles within the wireline security group are also presented on the right side of the user interface 723 based on the top-level selection of the wireline security group on the left side of the user interface 723. Using the user interface 723, system administrators may manage cube and database access for the wireline security group as a whole or for individual roles within the wireline security group. In one scenario, for instance, an administrator may add a new cube to the wireline security group, resulting in the automatic creation of the new cube with all of the filters that existed on the previously created cubes of the wireline security group.

FIGS. 7I and 7J illustrate management of user data access. As depicted, in FIG. 7I, user interface 725 may enable a system administrator to add users, modify data access of users, delete users, etc. As shown, selection of a user in the left section of the user interface 725 may result in a display of the selected user's details that includes the function security and data security associated with the user on the right section of the user interface 725. In one use case, for instance, a system administrator may add dashboard access for a user by adding a role using the functional security sub-section (e.g., located in the right section of the user interface 725). In addition, the system administrator may add a data security group to the user by using the data security sub-section (e.g., located in the right section of the user interface 725). FIG. 7J, for instance, illustrates the assignment of dashboard roles (e.g., window 727a) and data groups (e.g., window 727b).

FIG. 7K illustrates management of roles of security groups. As shown, user interface 729 enables a system administrator to manage roles (e.g., wireline all viewer) and role groups (e.g., wireline all) associated with security groups (e.g., wireline). Upon selection of a role, role group, or security group, a details section may be presented on the right side of the user interface 729. As depicted, the right side of the user interface 729 allows the system administrator to assign new roles to a security group, modify roles (e.g., edit role descriptions using the pencil icon in the top right corner of the user interface 729), delete roles, etc.

FIGS. 7L and 7M illustrate data security management of security groups. As shown, in FIG. 7L, user interface 731 enables a system administrator to manage filters for security groups, for users within the security groups, etc. A system administrator may, for instance, create or delete filters for the security groups using the left side of the user interface 731, or assign new filters to a selected user of a security group. As depicted, in FIG. 7M, a pop-up window 733 may be presented when the “Create Filter” button on the left side of the user interface 731 is clicked that enable the system administrator to create new filters.

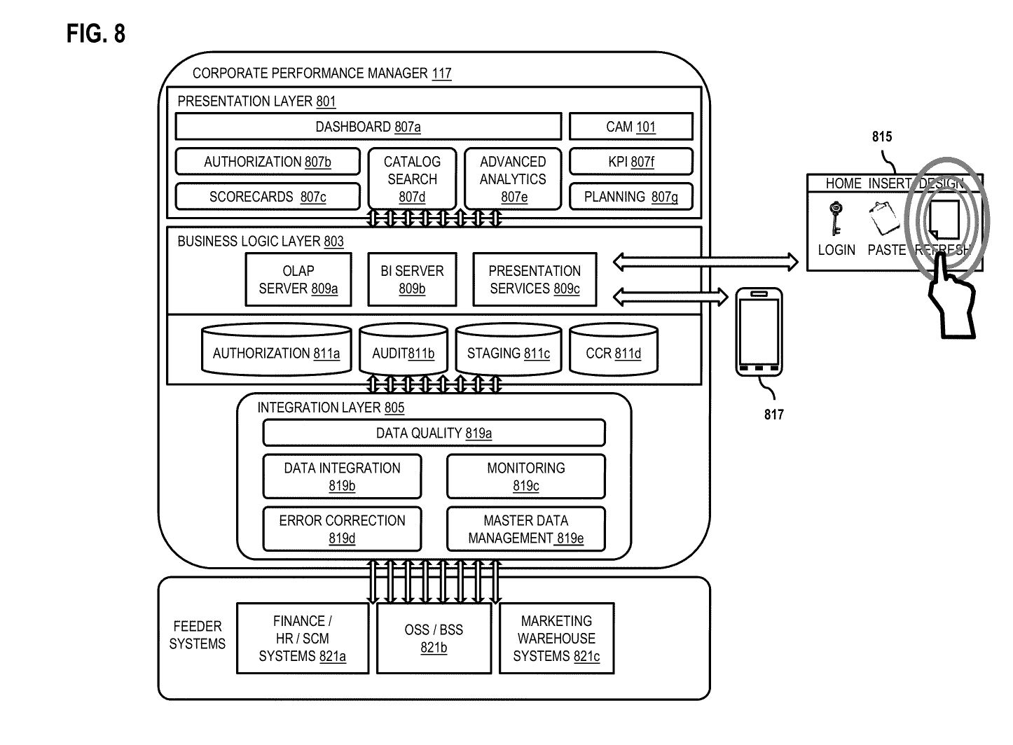

FIG. 8 is a diagram of various components of a corporate performance manager, according to an embodiment. As shown, the corporate performance manager 117 may include a presentation layer 801, a business logic layer 803, and an integration layer 805. The presentation layer 801 may, for instance, include components 807 (e.g., dashboard 807a, authorization 807b, scorecards 807c, catalog search 807d, advanced analytics 807e, KPI (key performance indicators) 807f, planning 807g, etc.) to provide data for presentation to users (e.g., LOB and corporate finance teams, marketing and engineering teams, etc.). In addition, the presentation layer 801 may include or have access to the common access manager 101 to manage access to data for presentation. For example, the common access manager 101 may provide granularity to reports, cubes, subject area and table levels, as well as the workflow to request access (e.g., workflow 600 of FIG. 6).

As depicted, the business logic layer 803 may include an OLAP (online analytical processing) server 809a, a BI (business intelligence) server 809b, and presentation services 809c, which may interact with databases 811 (e.g., authorization database 811a, audit database 811b, staging database 811c, CCR (centralized corporate repository) 811d, etc.). The authorization database 811a may store user entitlements, the audit database 811b may store user actions and history information, the staging database 811c may store staging data, and the CCR 811d may store dimensional representations of data. Moreover, the business logic layer 803 may provide robust integration for desktop and mobile applications 815 and 817.

The integration layer 805 may include a data quality module 819a, a data integration module 819b, a monitoring module 819c, an error correction module 819d, and a master data management module 819e. Modules 819 of the integration layer 805 may, for instance, pull and integrate data from multiple feeder systems 821 (e.g., finance/human resource/supply chain management systems 821a, OSS/BSS (operations support systems/business support systems) 821b, marketing warehouse systems 821c, etc.) for use by the corporate performance manager 117 and/or the common access manager 101.

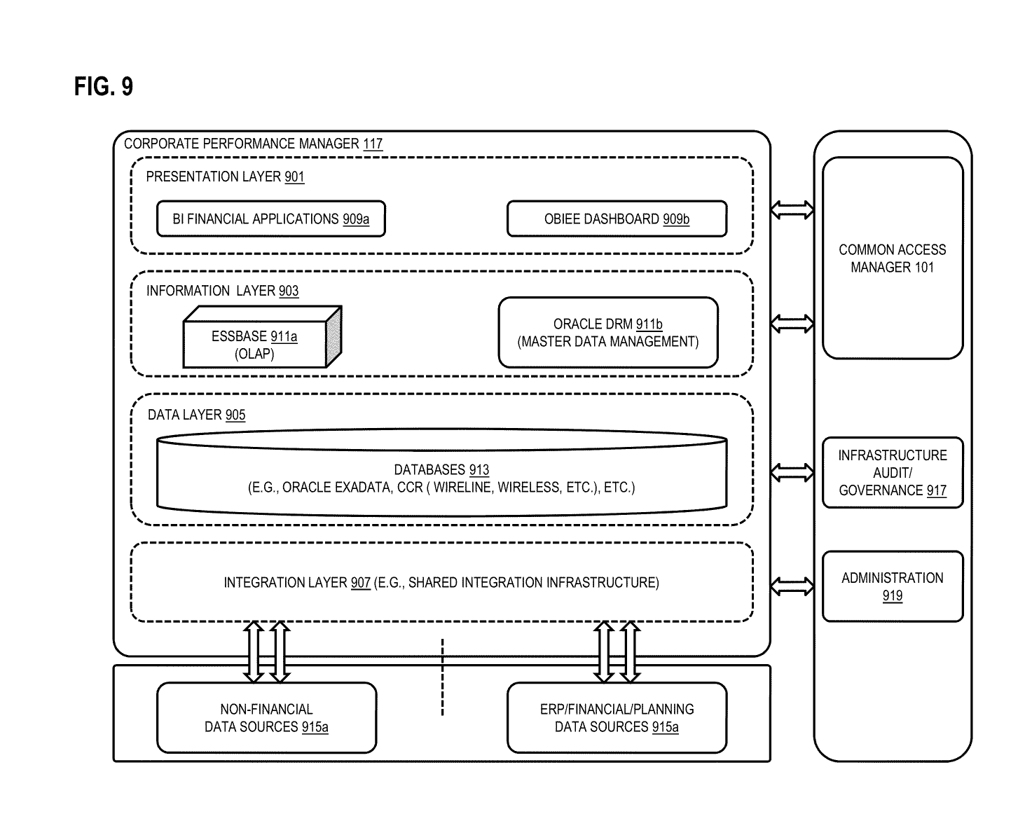

FIG. 9 is another diagram of various components of a corporate performance manager, according to an embodiment. As shown, the corporate performance manager 117 may include a presentation layer 901, an information logic layer 903, a data layer 905, and an integration layer 907. The presentation layer 901 may include BI financial applications 909a and an OBIEE dashboard application 909b. BI applications 909a may include prebuilt content that contain rich subject areas to build thousands of additional reports and dashboards quickly with little incremental effort. Moreover, the dashboard application 909b may provide the ability to federate various underlying data sources and present them to the user in a standard format for reporting. Moreover, the presentation layer 901 may feature interactive dashboard (e.g., via applications 909), ad-hoc queries and analysis capability, centralized repository of artifacts, PLAP analysis and reporting over non-OLAP data sources, built-in audits, and full integration with various office suites products (e.g., that include word processing applications, spreadsheet applications, etc.).

The information layer 903 may include Essbase 911 a and Oracle Hyperion DRM (Data Relationship Management) 909b. Oracle Hyperion DRM 911b may, for instance, be utilized to maintain various financial hierarchies (e.g., accounts, various roll-ups, etc.), act as a golden source for master data, maintain data relationships, etc. DRM 911b may also provide enterprise dimensions repository, supply hierarchy management, enforce business rules related to data management, offer version management, audit trail for data changes, support life cycle processes of data management, etc. Moreover, as depicted, the data layer 905 may include databases 913 (e.g., Oracle Exadata databases, CCR, etc.). In addition, the integration layer 907 may utilize a shared integration infrastructure to help streamline integration with all of the external systems (e.g., non-financial data sources 915a, ERP (enterprise resource planning)/financial/planning data sources 915b, etc.), to allow businesses full visibility to the data movement, and to initiate interface processing on demand and perform error correction. The shared integration infrastructure may also feature a single interface gateway for any type of interface development, a service-oriented architecture implementation, a metadata-driven orchestration, robust error correction capabilities, and end-to-end interface and data movement monitoring.

Furthermore, the common access manager 101 may interact with various components of the corporate performance manager 117. For example, the common access manager 101 may allow users to search for metrics/reports (e.g., based on data in databases 905) through the common dashboard (e.g., dashboard 909b) based on user access rights. The common access manager 101 may also enable requesting and provisioning of access to resources through an automated workflow (e.g., workflow 600 of FIG. 6). As such, the common access manager 101 may provide a more granular access to information (e.g., repository files, cubes, etc.), as well as compliance with security audit requirements (e.g., by defining policies for the users' accesses to resources, and tracking/monitoring the users' accesses to resources based on infrastructure audit/governance 915 and administration 917).

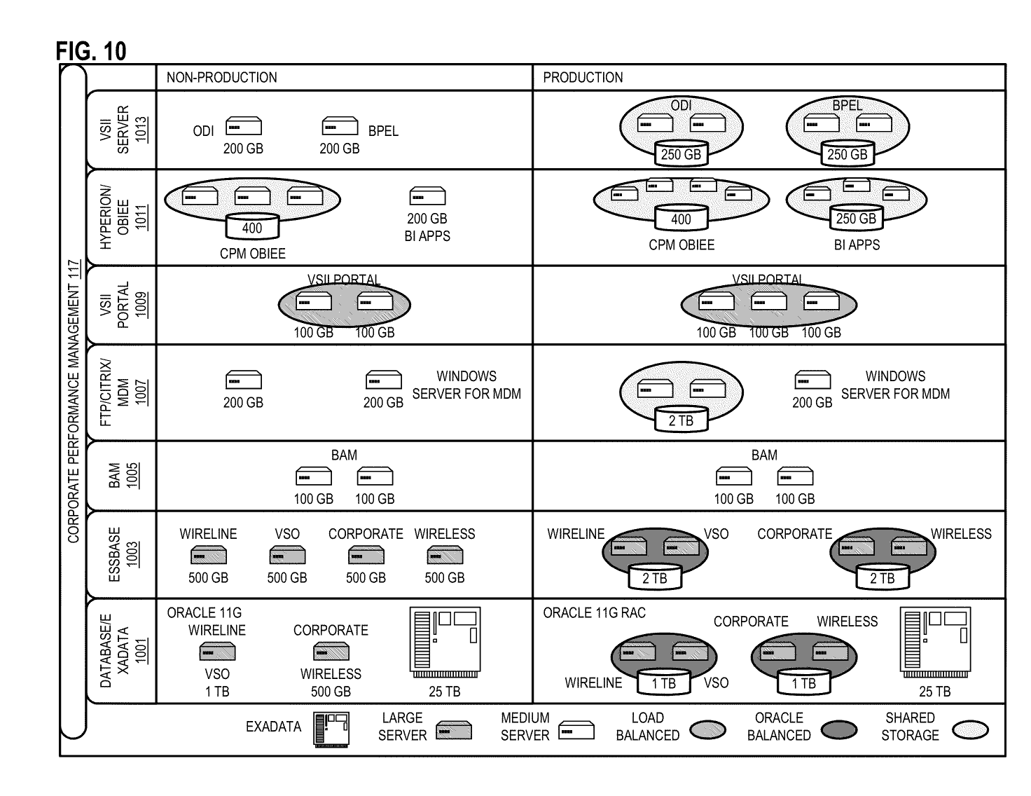

FIG. 10 is a diagram of an infrastructure architecture with respect to a corporate performance manager, according to an embodiment. As illustrated, the corporate performance manager 117 (and/or the common access manager 101) may support data management for numerous systems, such as systems 1001, 1003, 1005, 1007, 1009, 1011, and 1013. In addition, as depicted, these systems may include both non-production and product components.

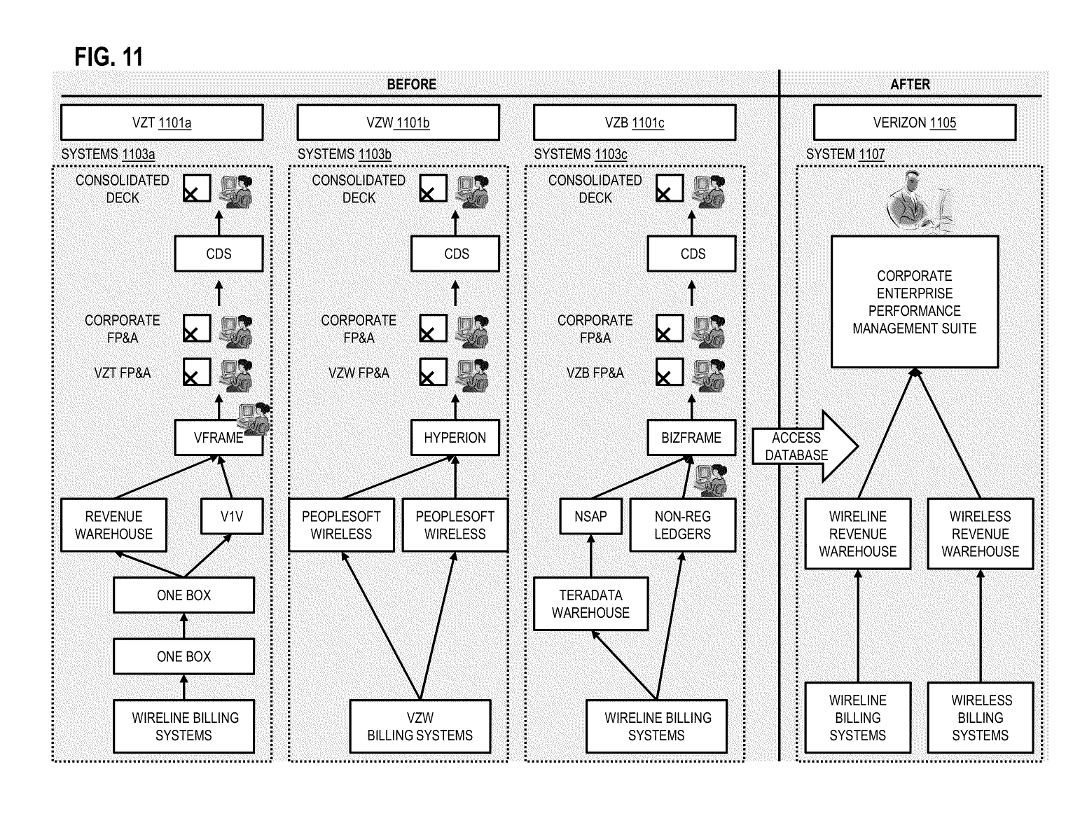

FIG. 11 is a diagram illustrating a before/after scenario with respect to implementation of a corporate performance manager and/or a common access manager, according to an embodiment. As shown, the corporate performance manager 117 and/or the common access manager 101 enable users of numerous entities or sub-entities (e.g., LOBs 1101a-1101c) having a variety of systems (e.g., systems 1103a-1103c) based on different database management systems and system types to access resources from any of the various databases of the numerous entities/sub-entities as if all of the entities/sub-entities were one single entity/sub-entity (e.g., corporation 1105) having system 1107.

The processes described herein for providing data access via a common access manager configured to support security for multiple database management system types may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 12 is a diagram of a computer system that can be used to implement various embodiments. The computer system 1200 includes a bus 1201 or other communication mechanism for communicating information and one or more processors (of which one is shown) 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk, flash storage, or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. Additional output mechanisms may include haptics, audio, video, etc. An input device 1213, such as a keyboard including alphanumeric and other keys, is coupled to the bus 1201 for communicating information and command selections to the processor 1203. Another type of user input device is a cursor control 1215, such as a mouse, a trackball, touch screen, or cursor direction keys, for communicating direction information and command selections to the processor 1203 and for adjusting cursor movement on the display 1211.

According to an embodiment of the invention, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement the embodiment of the invention. Thus, embodiments of the invention are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an embodiment of the invention through the network 1225, the local network 1221 and the communication interface 1217. The processor 1203 may execute the transmitted code while being received and/or store the code in the storage device 1209, or other non-volatile storage for later execution. In this manner, the computer system 1200 may obtain application code in the form of a carrier wave.

The term “computer-readable medium” as used herein refers to any medium that participates in providing instructions to the processor 1203 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

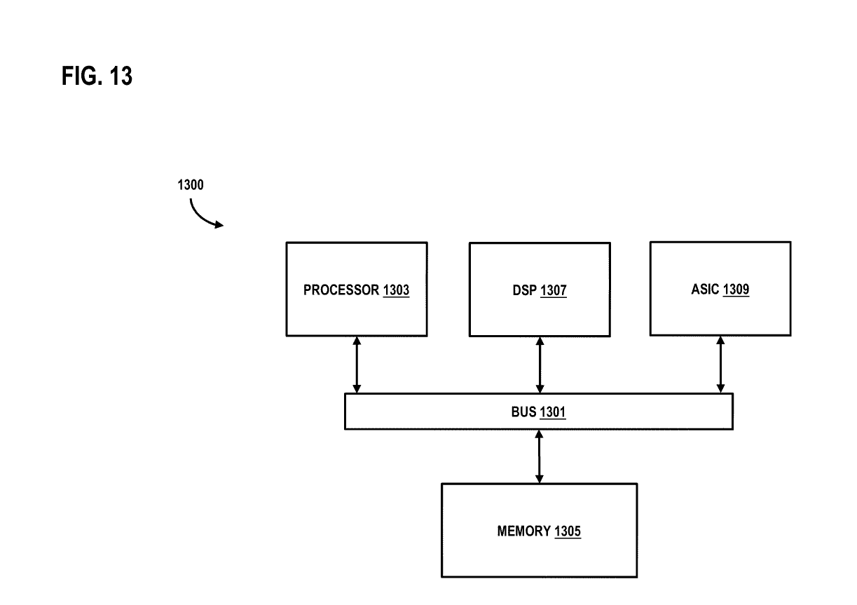

FIG. 13 illustrates a chip set or chip 1300 upon which an embodiment of the invention may be implemented. Chip set 1300 is programmed to enable data access via a common access manager configured to support security for multiple database management system types as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of enabling data access via a common access manager configured to support security for multiple database management system types.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to enable data access via a common access manager configured to support security for multiple database management system types. The memory 1305 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining, by a common access manager configured to support security for a plurality of database management system types, a request specifying access for a user to a feature associated with one of the database management system types;
determining a first-level approval of the access request by a first-level approver;
forwarding the access request to a second-level approver based on the first-level approval; and
initiating provisioning of the access to the feature for the user based on a second-level approval by the second-level approver.

2. A method according to claim 1, wherein the access request further specifies access for the user to another feature associated with another one of the database management system types.

3. A method according to claim 1, wherein the common access manager is further configured to integrate data from a plurality of source systems associated with the database management system types.

4. A method according to claim 1, further comprising:
assigning the access request to another first-level approver based on the determination of the access request by the common access manager; and
reassigning the access request to the first-level approver based on a reassignment with respect to approving the access request, wherein the first-level approval is based on the reassignment of the access request.

5. A method according to claim 1, further comprising:
determining a selection of a filter for the access to the feature, wherein the access request indicates the selection of the filter, and the provisioning of the access is based on the selection of the filter.

6. A method according to claim 1, further comprising:
determining that the first-level approver, the second-level approver, or a combination thereof has requested additional information with respect to the access request; and
initiating an action to satisfy the additional information request.

7. A method according to claim 1, further comprising:
initiating cancellation of the access request prior to completion of the provisioning of the access based on a withdrawal by an initial submitter of the access request, the user, or a combination thereof.

8. A method according to claim 1, wherein the feature is associated with a role, a data group, a product, or a combination thereof.

9. An apparatus comprising:
at least one processor; and
at least one memory including computer program code for one or more programs,
the at least one memory and the computer program code configured to, with the at least one processor, cause the apparatus to perform at least the following,
determine, by a common access manager configured to support security for a plurality of database management system types, a request specifying access for a user to a feature associated with one of the database management system types;
determine a first-level approval of the access request by a first-level approver;
forward the access request to a second-level approver based on the first-level approval; and
initiate provisioning of the access to the feature for the user based on a second-level approval by the second-level approver.

10. An apparatus according to claim 9, wherein the access request further specifies access for the user to another feature associated with another one of the database management system types.

11. An apparatus according to claim 9, wherein the common access manager is further configured to integrate data from a plurality of source systems associated with the database management system types.

12. An apparatus according to claim 9, wherein the apparatus is further caused to:
assign the access request to another first-level approver based on the determination of the access request by the common access manager; and
reassign the access request to the first-level approver based on a reassignment with respect to approving the access request, wherein the first-level approval is based on the reassignment of the access request.

13. An apparatus according to claim 9, wherein the apparatus is further caused to:
determine a selection of a filter for the access to the feature, wherein the access request indicates the selection of the filter, and the provisioning of the access is based on the selection of the filter.

14. An apparatus according to claim 9, wherein the apparatus is further caused to:
determine that the first-level approver, the second-level approver, or a combination thereof has requested additional information with respect to the access request; and
initiate an action to satisfy the additional information request.

15. An apparatus according to claim 9, wherein the apparatus is further caused to:
initiate cancellation of the access request prior to completion of the provisioning of the access based on a withdrawal by an initial submitter of the access request, the user, or a combination thereof.

16. An apparatus according to claim 9, wherein the feature is associated with a role, a data group, a product, or a combination thereof.

17. A system comprising:
one or more processors configured to execute a common access manager that is configured to support security for a plurality of database management system types,
wherein the common access manager is further configured to determine a request specifying access for a user to a feature associated with one of the database management system types and to another feature associated with another one of the database management system types.

18. A system according to claim 17, wherein the common access manager is further configured to:
determine a first-level approval of the access request by a first-level approver;
forward the access request to a second-level approver based on the first-level approval; and
initiate provisioning of the access to the feature for the user based on a second-level approval by the second-level approver.

19. A system according to claim 17, wherein the common access manager is further configured to:
assign the access request to another first-level approver based on the determination of the access request by the common access manager; and
reassign the access request to the first-level approver based on a reassignment with respect to approving the access request, wherein the first-level approval is based on the reassignment of the access request.

20. A system according to claim 17, wherein the feature is associated with a role, a data group, a product, or a combination thereof, and the other feature is associated with another role, another data group, another product, or a combination thereof.
